(19) United States
(12) Patent Application Publication
(10) Pub. No.: US 2005/0141402 A1
(43) Pub. Date: Jun. 30, 2005

(54) Multi-recording medium and storage medium

(75) Inventor: Tetsuo Hosokawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/064,388

(22) Filed: Feb. 23, 2005

Related U.S. Application Data
(63) Continuation of application No. PCT/JP02/12480, filed on Nov. 29, 2002.

(51) Int. Cl. G11B 7/24

(52) U.S. Cl. 369/275.3; 369/13.35

(57) ABSTRACT

Provided are a multi-recording medium having recorded thereon mixing information to be used upon synchronously reproducing contents, and a multi-recording reproduction device. An optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, by using the multi-recording reproduction device, it is possible to change the mixing conditions during synchronous reproduction, or record the changed mixing conditions as new mixing information in a RAM unit. Thereby, the virtual session function and multi-recording function, which were used only by certain professionals, can be realized easily and inexpensively.

### TECHNICAL FIELD

The present invention relates to a storage device and a recording medium to be used for synchronously synthesizing and reproducing a plurality of contents recorded in the medium, and particularly to a storage device and recording medium for synchronously reproducing a plurality of contents according to the recorded mixing information.

### BACKGROUND ART

In addition to enjoying music by reproducing the likes of a CD (Compact Disc) as a ROM (Read Only Memory) with music contents recorded thereon in advance, or by recording the music source of a CD on the likes of an MD (Mini Disk) employing a magneto-optical medium and reproducing this on an MD system, people also enjoy music by performing one's instrument, and recording and reproducing such performance.

Overdubbing is a method of recording and reproducing instrumental performances. In overdubbing, different music is recorded in each track of a recording medium having a plurality of recording tracks. In other words, music is recorded in the first track in advance, and, while playing and listening to such music, sound is overdubbed and recorded in a different track. For example, as a result of recording a piano first, and then recording a guitar while listening to the sound of such piano, the simultaneous playback of the piano and guitar is enabled. In order to record while playing a plurality of tracks of music, or to simultaneously record a plurality of tracks of music, a high-speed, large-capacity storage device is required, and a hard disk is primarily used for this purpose.

Nevertheless, an overdubbing system employing a hard disk requires sophisticated editing techniques since the purpose is music production, and the operation thereof is complicated. Thus, although some people use the overdubbing system employing a hard disk, this system has not gain popularity in general. Further, since a magnetic recording medium such as a hard disk does not have a ROM unit such as phase pits of an optical disk, there is a problem in that, in order to record music in advance, it is necessary to magnetically record music for each medium, and the manufacturing cost increases as a result thereof.

An overdubbing system employing an MD (Mini Disk) as the medium, which is easier to handle in comparison to a hard disk, has also been realized. Although the medium will be inexpensive as a result of using an MD, the point of the user having to ordinally record music in a plurality of tracks is the same as the device employing a hard disk. In order to record music information in advance at the time of shipping, as with a hard disk, this requires magneto-optical recording for each MD, and the medium cost will increase. Further, there is another problem in that the recordable capacity will decrease in an amount corresponding to the amount prerecorded in the plurality of tracks. Thus, although certain professionals use the conventional overdubbing system employing a recordable MD, this system has not gained popularity in general.

As described above, excluding certain professionals, the method of enjoying music by overdubbing or synchronously reproducing overdubbed music has not gain popularity in general.

In recent years, a concurrent ROM/RAM system and partial ROM system have been introduced as methods having the potential of realizing the functions of overdubbing and synchronous reproduction inexpensively. For example, Japanese Patent Laid-Open Publication No. H7-65375 proposes a method of synchronizing, with music or image information prerecorded in a ROM unit employing phase pits, different music or image information and recording this at the same position in a RAM unit. Further, Japanese Patent Laid-Open Publication No. H5-151758 and Japanese Patent Laid-Open Publication No. H11-7729 propose methods of employing a partial ROM system and synchronously reproducing, temporally, separately recorded music information.

Nevertheless, every proposal relates to a method of temporally synchronizing contents, and the adjustment of mixing conditions such as the output level ratio or waveform characteristic upon synchronously reproducing (mixing) a plurality of contents are unclear. For example, when multi-recording and reproducing music contents, in addition to the temporal synchronization of the respective music contents being required, the adjustment of mixing conditions upon mixing is also essential. It will be extremely difficult to listen to music of sufficient quality based on mixing without any adjustment of the output ratio or waveform.

Generally speaking, since it is difficult to anticipate and determine the optimum output ratio or amount of waveform adjustment of the respective music contents at the time of recording, it is preferable that these items may be freely set at the time of reproduction after recording. Moreover, it is necessary to change the output during the song. For instance, when overdubbing a guitar performance while reproducing a ROM unit having vocals and a musical accompaniment recorded thereon in advance, it is standard to insert an interlude between the first verse and second verse of the song. In order to record a loud guitar solo during this interlude and to record a quiet rhythm part in other sections of the song, it is necessary to change the mixing conditions at an arbitrary timing during the song.

Since this mixing information is to be set specifically for the respective music contents, it is desirable that such mixing information be recorded in the individual recording mediums. Further, this must be something that can be easily set in accordance with the user's preference.

In addition, as another method relating to multi-recording, Japanese Patent Laid-Open Publication No. 2002-171482 discloses a method of multi-recording after optimally adjusting the audio data output in advance. Nevertheless, since it is necessary to readjust the volume ratio with the reproduction device after recording, it is difficult to realize high-quality music reproduction at any place.

Moreover, as a method of adjusting the volume among the mixing conditions, Japanese Patent Laid-Open Publication No. 2000-173171 discloses a method of enabling the recording of the sound level of the respective music contents in a TOC (Table Of Contents) area. Nevertheless, since the volume adjustment is made for each song, it is not possible to synchronously reproduce, in high quality, the plurality of multi-recorded music contents.

### DISCLOSURE OF THE INVENTION

An object of the present invention is to realize, easily and inexpensively, the multi-recording function and synchronous reproduction function of the multi-recorded contents in which the use thereof was limited to certain professionals, and to provide a storage device and multi-recording medium for reproducing the contents in sufficient quality.

Another object of the present invention is to provide a multi-recording medium and storage device capable of synchronously synthesizing a plurality of contents recorded in a multi-recording medium, and recreating the contents without having to set the mixing information for reproduction each time such contents are to be reproduced.

A further object of the present invention is to provide a multi-recording medium and storage device capable of synchronously synthesizing a plurality of contents, and changing the mixing information upon reproduction, or recording the changed setting.

The foregoing object is achieved with the first mode of the present invention which provides a disk-like multi-recording medium in which a ROM unit having information recorded therein with phase pits employing optical reflectance and a RAM unit being optically recordable and reproducible are arranged in layers, comprising: a first area having first contents; a second area having second contents; and a third area having mixing information to be used upon synchronously synthesizing and reproducing the first and the second contents.

Preferably, the foregoing object is achieved with the second mode which provides a multi-recording medium according to the first mode described above, wherein the first area is formed in the ROM unit; the second and the third areas are formed in the RAM unit; and the ROM unit and the RAM unit are arranged in an overlapping manner.

Further, preferably, the foregoing object is achieved with the third mode which provides a multi-recording medium according to the first mode described above, wherein the first and the second areas are formed in the read-only ROM unit; the third area is formed in the rewritable RAM unit; and the ROM unit and the RAM unit are arranged in an overlapping manner.

Moreover, the foregoing object is achieved with the fourth mode which provides a disk-like multi-recording medium in which a ROM unit having information recorded therein with phase pits employing optical reflectance and a RAM unit being optically recordable and reproducible are arranged at positions differing in the radial direction or at positions differing in the circumferential direction, wherein a first area having first contents is formed in the ROM unit; and a second area having second contents, and a third area having mixing information to be used upon synchronously synthesizing and reproducing the first and the second contents are formed in the RAM unit.

Further, preferably, the foregoing object is achieved with the fifth mode which provides a multi-recording medium according to any one of the second to fourth modes described above, wherein the RAM unit is formed with a magneto-optical recording film.

Moreover, preferably, the foregoing object is achieved with the sixth mode which provides a multi-recording medium according to any one of the first to fourth modes described above, wherein the mixing information has output level ratio information of the first and the second contents or waveform characteristic information of the first and the second contents.

Further, preferably, the foregoing object is achieved with the seventh mode which provides a multi-recording medium according to the sixth mode described above, wherein the mixing information further has timing information for changing the output level ratio or the waveform characteristic during synchronous reproduction.

The foregoing object is achieved with the eighth mode which provides a storage device, comprising: an optical pickup for irradiating light to a multi-recording medium including a read-only ROM unit having first contents recorded with phase pits employing optical reflectance and a rewritable RAM unit having second contents and mixing information, and separating and detecting the information of the ROM unit and the RAM unit; a magnetic head for recording information in the RAM unit used with the irradiated light; and a controller for synchronously synthesizing the first and the second contents according to the mixing information and generating a reproduction signal.

Preferably, the foregoing object is achieved with the ninth mode which provides a storage device according to the eighth mode described above, wherein the controller further has a mixing condition input unit for inputting mixing information; and the mixing information input during the synchronous reproduction of the first and the second contents is recorded in the RAM unit

Moreover, preferably, the foregoing object is achieved with the tenth mode which provides a storage device according to the eighth mode described above, wherein the controller further has a mixing condition input unit for inputting mixing information; and the reproductive state of the first and the second contents is changed according to the mixing information input during the synchronous reproduction of the first and the second contents.

Further, preferably, the foregoing object is achieved with the eleventh mode which provides a storage device according to any one of the eighth to tenth modes described above, wherein the mixing information has output level ratio information of the first and the second contents or waveform characteristic information of the first and the second contents.

Moreover, preferably, the foregoing object is achieved with the twelfth mode which provides a storage device according to the eleventh mode described above, wherein the mixing information has timing information for changing the output level ratio or the waveform characteristic during synchronous reproduction.

Further, preferably, the foregoing object is achieved with the thirteenth mode which provides a storage device according to the twelfth mode described above, wherein the controller changes the first or the second output level ratio or waveform characteristic based on the timing information during synchronous reproduction.

Moreover, the foregoing object is achieved with the fourteenth mode which provides a storage device, comprising: an optical pickup for irradiating light to a multi-recording medium including a read-only ROM unit having first contents recorded with phase pits employing optical reflectance and a rewritable RAM unit having second contents and mixing information, and detecting the information of the ROM unit and the RAM unit; a buffer memory for temporarily storing the first and the second contents detected with the optical pickup; a magnetic head for recording information in the RAM unit used with the irradiated light; and a controller for synchronously synthesizing the first and the second contents stored in the buffer memory according to the mixing information and generating a reproduction signal.

As described above, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, the multi-recording reproduction device can be used to change the mixing conditions during synchronous reproduction, or record the changed mixing conditions as new mixing information in a RAM unit. Thereby, the virtual session function and multi-recording function, which were limited to certain professionals, can be realized easily and inexpensively.

### BRIEF DESCRIPTION OF THE DRAWINGS

FIG. 1 is a configuration of the multi-recording reproduction system in an embodiment according to the present invention;

FIG. 2 is a diagram showing a configuration example of the concurrent ROM/RAM medium;

FIG. 3 is a diagram showing the ROM information and RAM information in the concurrent ROM/RAM medium;

FIG. 4 is a diagram showing an embodiment of the multi-recording medium according to the present invention;

FIG. 5 is a diagram showing an example of the data format of the RAM unit;

FIG. 6 is a diagram showing another example of the multi-recording medium according to the present invention;

FIG. 7 is a diagram showing an example of the data format to be recorded in the TOC area;

FIG. 8 is a diagram showing another embodiment of the multi-recording medium according to the present invention;

FIG. 9 is a diagram showing another embodiment of the multi-recording medium according to the present invention;

FIG. 10 is a diagram showing another embodiment of the multi-recording medium according to the present invention;

FIG. 11 is a diagram showing a configuration example of the multi-recording reproduction device;

FIG. 12 is a block diagram showing a configuration example of the multi-recording reproduction device;

FIG. 13 is a diagram showing the combination of the detection of signals in the respective modes;

FIG. 14 is a block diagram showing an embodiment of the main controller; and

FIG. 15 is a block diagram showing another embodiment of the main controller.

### BEST MODE FOR CARRYING OUT THE INVENTION

Embodiments of the present invention are now explained with reference to the drawings. Nevertheless, the technical scope of the present invention is not limited to such embodiments. Incidentally, although music contents are taken as the example for explanations in the embodiments, the effect of the present invention is not limited to music, and similar effects can be achieved with images and the like. Further, in the embodiments of the present invention, although the storage device of the present invention is explained upon being referred to as a multi-recording reproduction device, the target medium is not limited to a multi-recording medium.

Embodiments of the multi-recording medium, embodiments of the multi-recording reproduction device, and modes of application employing such multi-recording medium and multi-recording reproduction device according to the present invention are now explained in order.

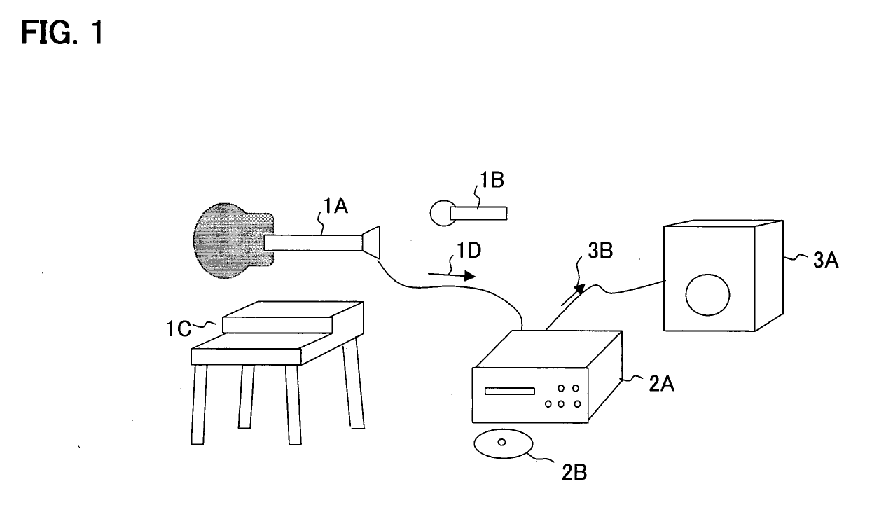

FIG. 1 is a configuration of the multi-recording reproduction system in an embodiment according to the present invention. FIG. 1 is explained taking as examples the multi-recording method and synchronous reproduction method of music contents. The performer will use an input device such as a guitar 1A, microphone 1B and piano 1C to play music. The performed sound is converted in an electronic signal, and then input to a multi-recording reproduction device 2A. The multi-recording reproduction device 2A, after converting the input electronic signal into a digital signal via an analog/digital (A/D) converter, records this in a multi-recording medium 2B.

Here, music ROM information (music contents) prerecorded as phase pits, for example, are read out by the same multi-recording medium 2B, and the multi-recording reproduction device 2A synchronously synthesizes the performed sound and read music ROM information, executes digital/analog (D/A) conversion on this, and thereafter outputs the synthesized electronic signal to an output device such as a speaker 3A. Overdubbing and synchronous reproduction are conducted thereby.

Music ROM information, for example, may be a band performance of drums, bass, guitar, chorus and vocals other than the instrumentally performed part, or may be an orchestra performance. This may also be a metronome sound.

In any case, the instrumental performance is conducted while listening to the music information recorded in the ROM of this multi-information recording medium 2B. In other words, a virtual session with a band or orchestra is realized. And, simultaneously with the reproduction of this music ROM information, the instrumental performance is recorded in the multi-recording medium 2B.

Although FIG. 1 illustrates a signal 1D from a guitar as the input signal to the multi-recording reproduction device 2A, this may also be a signal from a microphone, piano or a different instrument or sound source, or a synthesized signal of such instruments or the like may be used. If a concurrent ROM/RAM medium described later is to be used as the multi-recording medium 2B, for example, this input signal 1D is recorded in a RAM unit formed from a magneto-optical recording film. Further, in the case of the partial ROM disk described later, the input signal 1D is recorded in the RAM unit.

The output signal 3B to the speaker 3A depicted in FIG. 1 is the reproduction signal of the music information prerecorded as the ROM in the multi-recording medium 2B. Moreover, the music information prerecorded as the ROM may be synthesized with the performance sound input to the multi-recording reproduction device 2A, and output with the speaker 3A. In addition, the speaker 3A may be built in the multi-recording reproduction device 2A. Although not shown, a headphone may also be used as the output device.

Since the ROM unit is not provided with a plurality of tracks assigned to the respective instruments, but rather the performance of an orchestra or band is collectively recorded therein, complex adjustments of the volume and tone required in conventional multi-track recording are not required, and high-quality music can be enjoyed easily. Needless to say, the performance of a single instrument may also be simply recorded in the ROM unit. As a result of recording a mixing information in the medium, music can be reproduced under the same conditions even when the reproduction device is changed. Further, there is no need to optimize the mixing conditions upon recording.

Next the multi-recording medium 2B of the present invention is explained.

[Multi-Recording Medium]

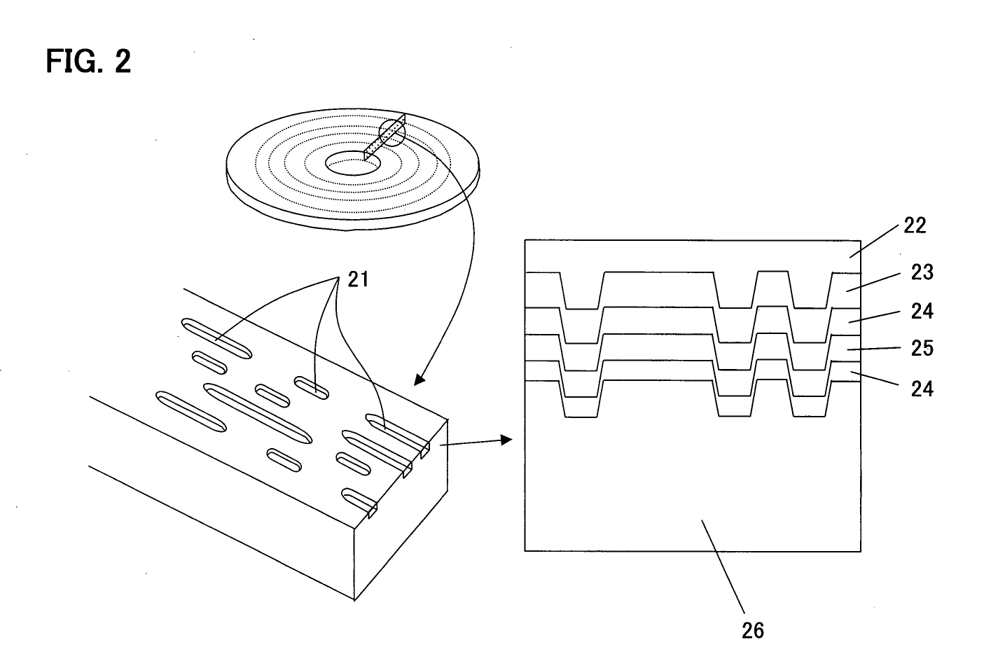

FIG. 2 is a diagram showing a configuration example of the concurrent ROM/RAM medium. Formed on a transparent substrate 26 are a protective coat 22, a reflective layer 23, a dielectric layer 24, and magneto-optical recording layer 25. Read-only ROM information is recorded with physically non-rewritable concavo-convex phase pits 21, and rewritable RAM information is recorded in the magneto-optical recording layer 25.

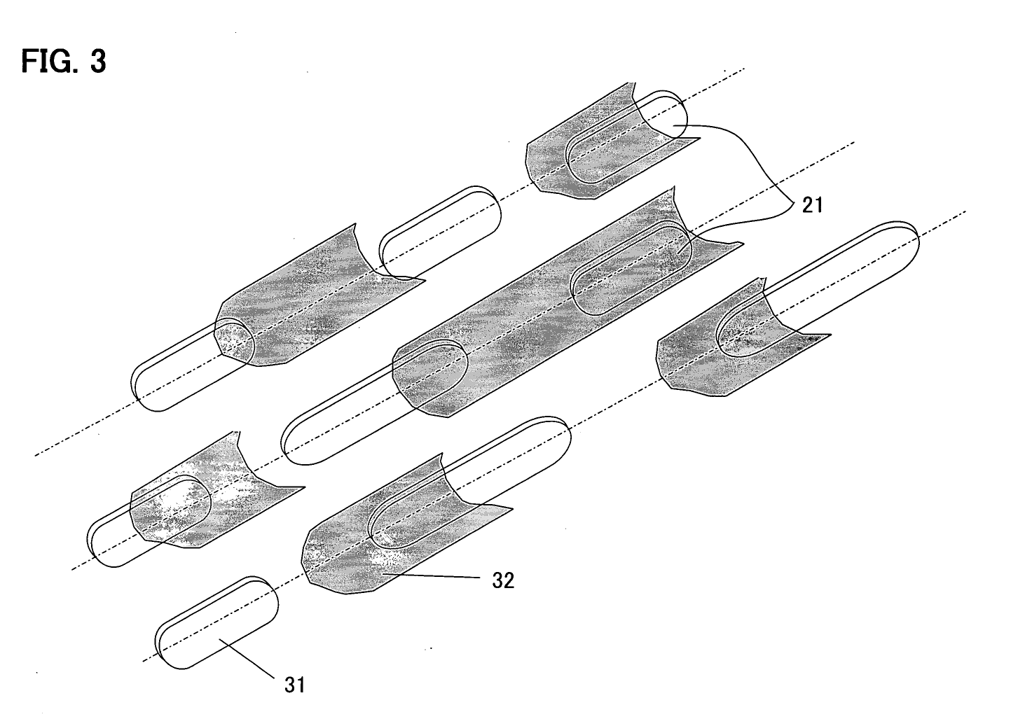

FIG. 3 is a diagram showing the ROM information and RAM information in the concurrent ROM/RAM medium. As explained in FIG. 2, ROM information 31 is recorded as a concavo-convex signal in the phase pit 21, and RAM information 32 is recorded in the magneto-optical recording layer 25 so as to overlap with the ROM information 31. Characteristics of the ROM information and RAM information being arranged in an overlapping manner are utilized to synchronously synthesize and reproduce the two. In the present description, the portion having ROM information recorded thereon is referred to as a ROM unit, and the portion having RAM information recorded thereon is referred to as a RAM unit.

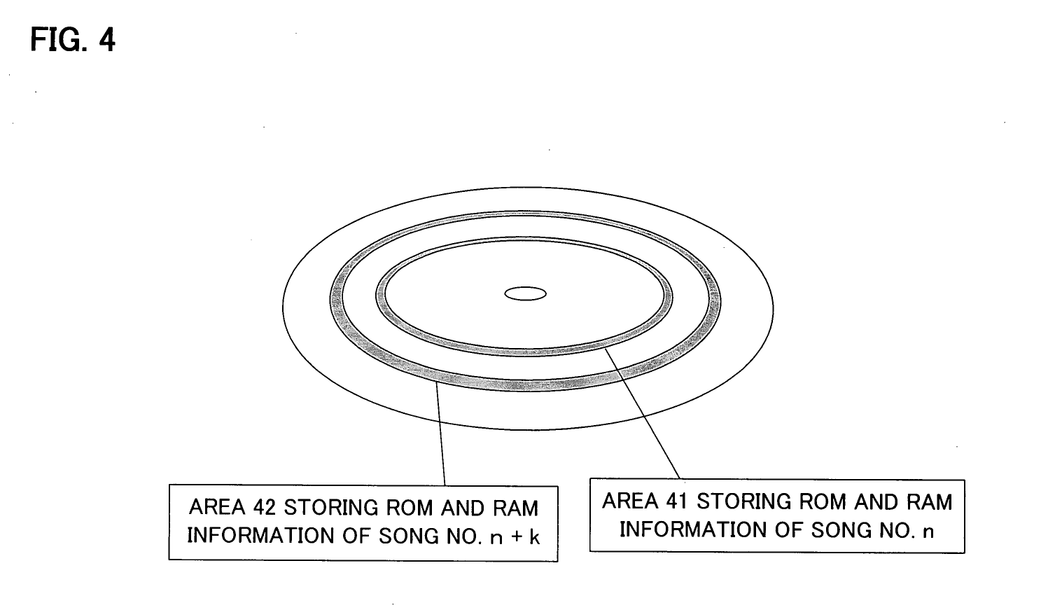

FIG. 4 is a diagram showing an embodiment of the multi-recording medium according to the present invention. A concurrent ROM/RAM medium is used as the medium. RAM information corresponding to ROM information of song number n is recorded in an overlapping manner in area 41, and RAM information corresponding to ROM information of song number n+k is recorded in an overlapping manner in area 42. As a result of utilizing the characteristics of the concurrent ROM/RAM medium, upon reproducing the ROM information of song number n, the corresponding RAM information can be synchronously reproduced. Similarly, song number n+k can also be synchronously reproduced.

Mixing information to be used upon synchronously reproducing the ROM information (first contents) of song number n of area 41 and the RAM information (second contents) corresponding thereto is recorded in the RAM unit of area 41. With respect to area 42, similarly, mixing information is recorded in the RAM unit of area 42.

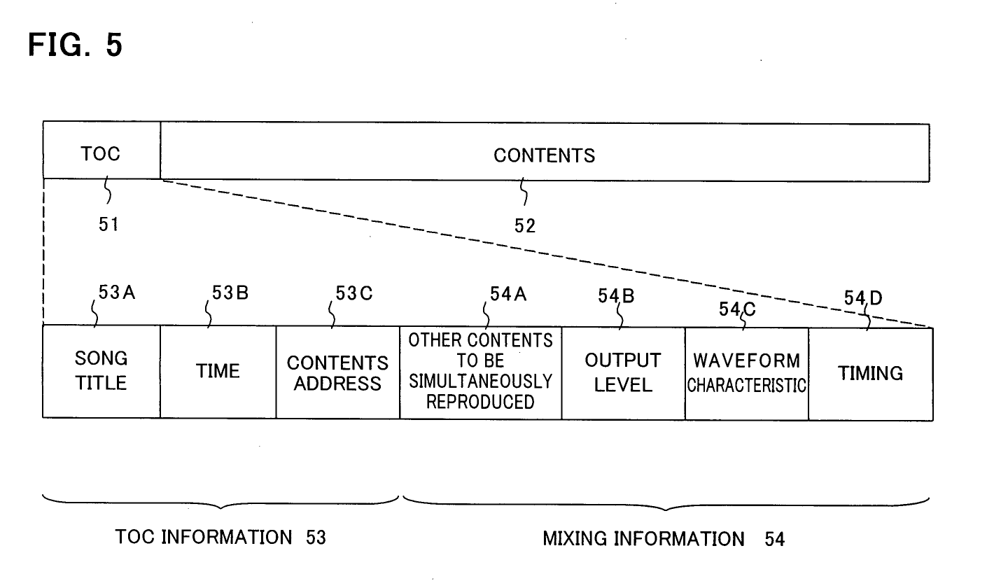

FIG. 5 is a diagram showing an example of the data format of the RAM unit in,the embodiment of FIG. 4. A TOC (Table Of Contents) area 51 exists that the head of the contents 52. In addition to a TOC information 53 such as the song title 53A of the contents 52, performance time 53B and the contents address 53C, the TOC area 51 includes the mixing information 54 such as other contents information 54A to be synchronously reproduced, as well as output level ratio information 54B, waveform characteristic information 54C and timing information 54D to be used upon synchronously reproducing the contents.

The contents address 53C is an address on the medium for showing the starting position of the contents 52. The contents are specified with the address. The other contents information 54A to be synchronously reproduced, in the case of area 41 illustrated in FIG. 4, is information for identifying the first contents corresponding to the RAM information (second contents). This may be the address of the first contents, and, if it capable of identifying the contents by numbers, such numbers may also be recorded therein.

The output level ratio information 54B has recorded therein the output level ratio of the respective contents to be synchronously reproduced. An absolute output level may be recorded instead of a relative ratio. For example, the output level is decided based on the volume or the like.

The waveform characteristic information 54C has recorded therein the waveform characteristic of the respective contents to be synchronously reproduced. A waveform characteristic, for instance, represents the intensity of each frequency band separated in a fixed range. Or, if there is a set mode (e.g., modes separated based on the acoustic environment status such as a concert hall mode, club mode and outside mode, or based on the performance mode such as vocals, classic, opera, orchestra and so on), this may be information for specifying such mode.

The timing information 54D has recorded thereon, for instance, medium address information of the timing applying the output level ratio information and waveform characteristic information. For example, mixing conditions are applied upon reproducing a designated address in the second contents.

Further, the timing information 54D may also have recorded thereon time information. For example, if one minute is designated, such output level ratio information and waveform characteristic information are applied for the initial one minute from the start of the synchronous reproduction. When changing the mixing conditions in a plurality of timings during the synchronous reproduction, a plurality of output level ratio information 52 and waveform characteristic information 53 is recorded for each changed section.

As the mixing information, information for controlling the frequency area, information for controlling the amplitude area, information for controlling the time area and so on may also be used. As information for controlling the frequency area, equalizer (graphic equalizer, parametric equalizer) information, filter information and so on may be considered. As information for controlling the amplitude area, for instance, compressor limiter information which changes in accordance with the amplitude of the input signal without making the input/output amplitude characteristics a linear relationship showing one-to-one correspondence like a standard amplifier, noise gate information for cutting signals under a prescribed level, expander information and so on may be considered.

As information for controlling the time area, digital delay information for obtaining an effect of thickening the sound by delaying the signal, digital reverb information for recreating the reverberation effect in a concert hall or the like, and so on may be considered. Therefore, for instance, the numerical value per frequency band set as equalizer information, the foregoing prescribed level set as noise gate information, and the delay time set as digital delay information may be recorded as the mixing information.

As illustrated in FIGS. 3, 4 and 5, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, if using the multi-recording reproduction device described later, it is possible to change the mixing conditions during synchronous reproduction, or to record the changed mixing conditions as new mixing information in a RAM unit.

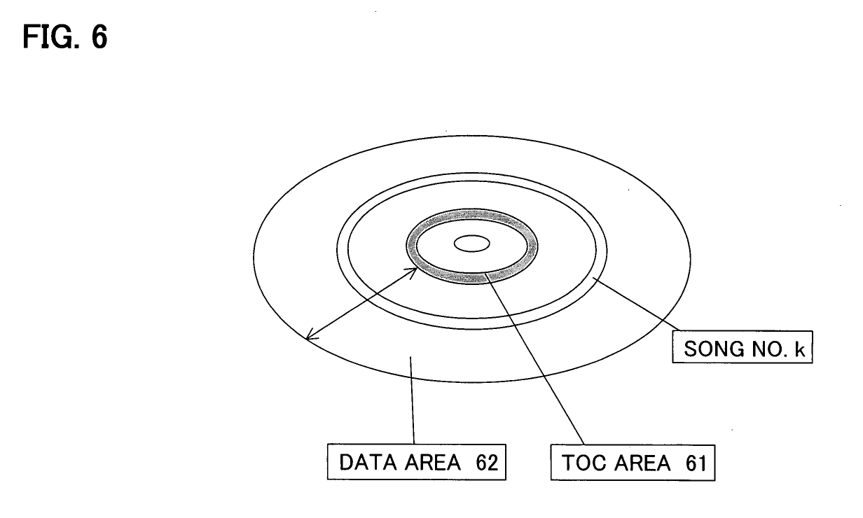

FIG. 6 is a diagram showing another example of the multi-recording medium according to the present invention. A concurrent ROM/RAM medium is used as the medium. In the embodiment depicted in FIG. 4, although a TOC area is provided to the respective contents, in this example, TOC of all contents is recorded in the TOC area provided to innermost periphery of the recording medium.

The TOC area 61 is different from the data area 62, and music contents are not recorded therein. Since this is a concurrent ROM/RAM medium, the TOC area 61 includes a ROM unit having recorded thereon ROM information employing phase pits, and a RAM unit having recorded thereon RAM information in a magnetic recording layer.

The ROM unit of the TOC area 61 has recorded thereon the TOC information of the contents recorded in the ROM unit of the data area 62, and the RAM unit of the data area 62 has recorded thereon the TOC information of the contents recorded in the RAM unit.

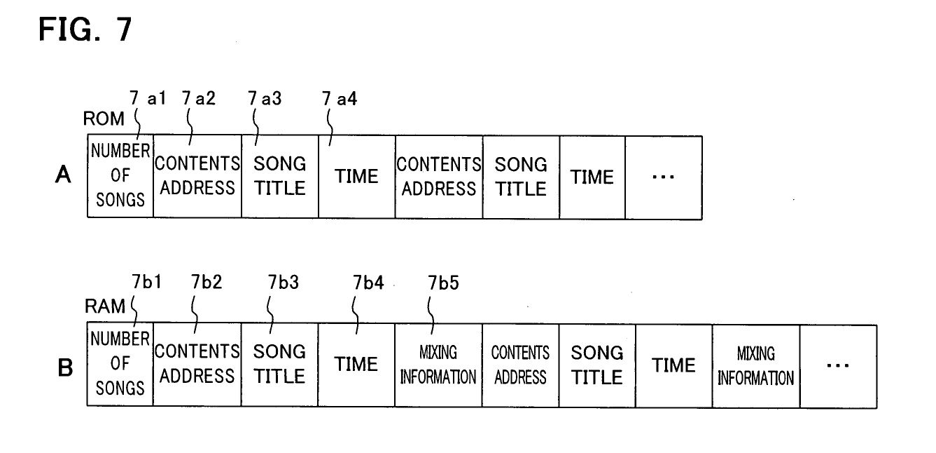

FIG. 7 is a diagram showing an example of the data format to be recorded in the TOC area. FIG. 7A is an example of the data format of the ROM unit of the TOC area 61, and includes the number of songs 7a1 recorded in the ROM unit of the data area 62, contents address 7a2, song title 7a3, and performance time 7a4. FIG. 7B is an example of the data format of the RAM unit of the TOC area 61, and includes the number of songs 7b1 recorded in the RAM unit of the data area 62, contents address 7b2, song title 7b3, performance time 7b4, and mixing information 7b5. The data format of the mixing information 7b5, for example, corresponds to the mixing information 54 depicted in FIG. 5.

As shown in FIGS. 6 and 7, as a result of arranging the TOC area containing mixing information at the innermost periphery of the recording medium, characteristics of the concurrent ROM/RAM medium can be utilized to simultaneously read the TOC information pertaining to the contents of both the ROM unit and RAM unit, and the operation speed of the device can be improved thereby.

Further, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, if using the multi-recording reproduction device described later, it is possible to change the mixing conditions during synchronous reproduction, or to record the changed mixing conditions as new mixing information in a RAM unit.

Incidentally, in FIG. 6, although the TOC area 61 is arranged in the innermost periphery of the recording medium, for instance, this may also be arranged in the outermost periphery.

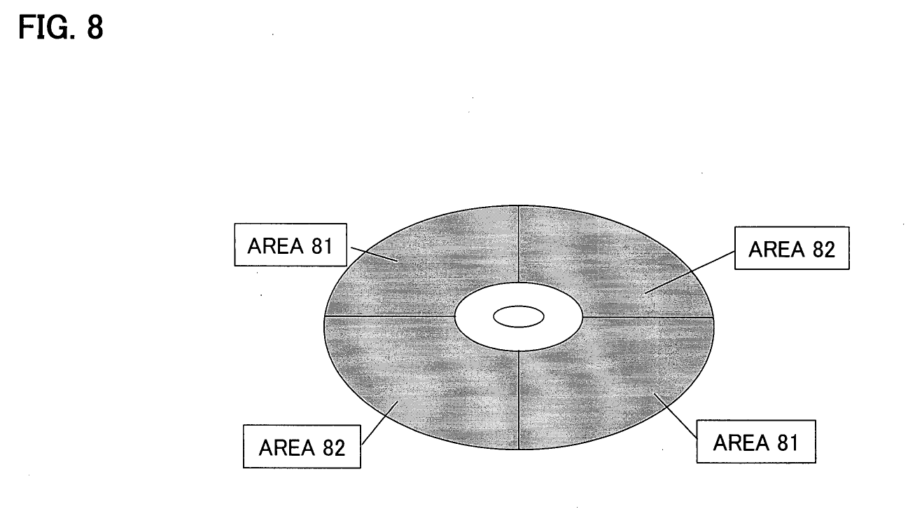

FIG. 8 is a diagram showing another embodiment of the multi-recording medium according to the present invention. A concurrent ROM/RAM medium is used as the medium. FIG. 8 shows an example that the ROM unit is divided into two or more sub areas, and mixing information to be used upon synchronously reproducing the contents of the respective sub areas is recorded in the RAM unit.

In FIG. 8, the first contents divided into two sub areas are recorded in one of the divided sub areas, the sub areas 81, the second contents are recorded in another of the divided sub areas, the sub areas 82, and the mixing information to be used upon synchronously reproducing the first and second contents is recorded in the RAM unit (not shown) overlapping with the ROM unit. The data format of mixing information to be recorded in the RAM unit, for example, is the same as the mixing information 54 illustrated in FIG. 5.

As a result of FIG. 8, mixing of a plurality of sound sources is enabled. In other words, by recording only drums and bass as the first contents and recording a guitar or chorus as the second contents, the user is able to freely select the mixing target.

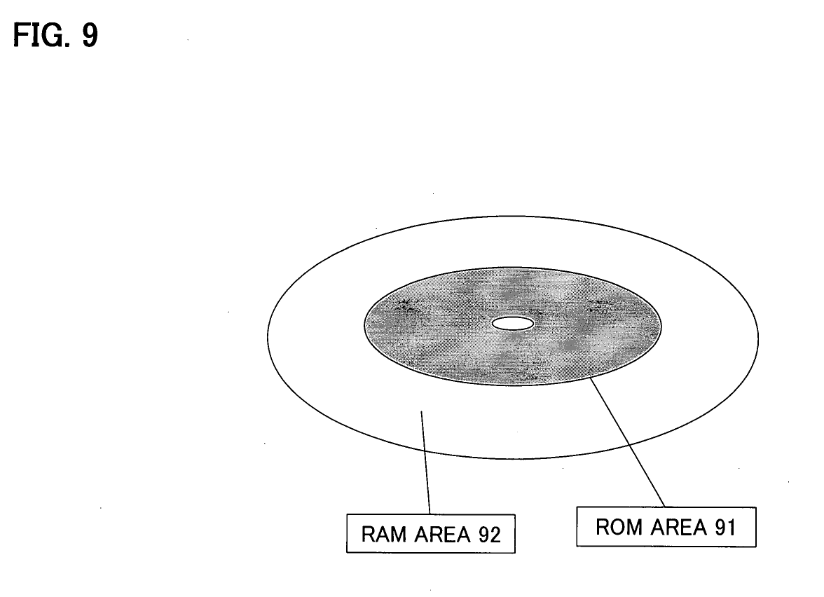

FIG. 9 is a diagram showing another embodiment of the multi-recording medium according to the present invention. In this example, employed is a recording medium in which the ROM unit and RAM unit are provided on the recording medium, but are not arranged in an overlapping manner.

In FIG. 9, the first contents are recorded in the ROM area 91, the second contents are recorded in the RAM area 92, and the mixing information to be used upon synchronously reproducing the first and second contents is recorded in the RAM area 92. The data format of the RAM area 92, for instance, is as shown in FIG. 5.

As shown in FIG. 9, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, if using the multi-recording reproduction device described later, it is possible to change the mixing conditions during synchronous reproduction, or to record the changed mixing conditions as new mixing information in a RAM unit.

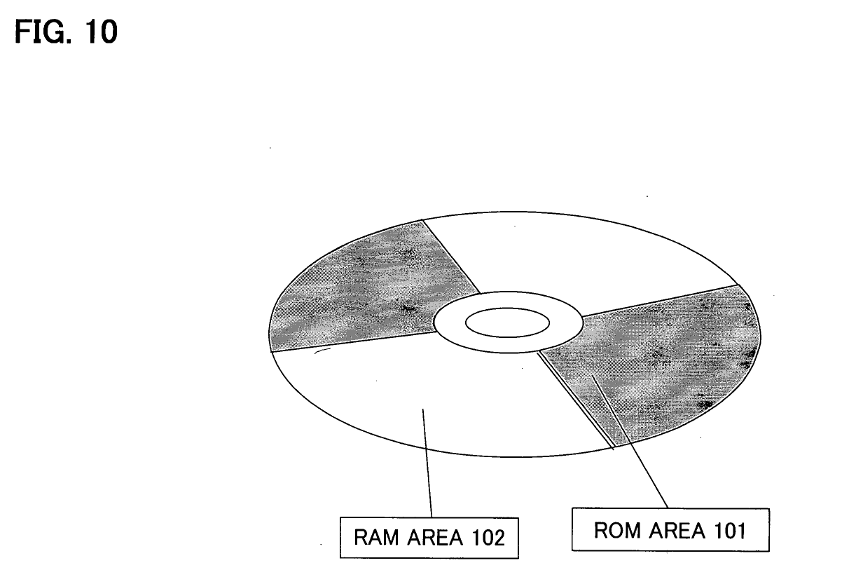

FIG. 10 is a diagram showing another embodiment of the multi-recording medium according to the present invention. In this example, employed is a recording medium in which the ROM unit and RAM unit are provided on the recording medium, but are not arranged in an overlapping manner.

In FIG. 10, unlike the example depicted in FIG. 9 where the ROM area and RAM area are divided in the radial direction, the ROM area 101 and RAM area 102 are divided in the peripheral direction. The first contents are recorded in the ROM area 101, the second contents are recorded in the RAM area 102, and the mixing information to be used upon synchronously reproducing the first and second contents is recorded in the RAM area 102. The data format of the RAM area 102, for instance, is as shown in FIG. 5.

As shown in FIG. 10, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, if using the multi-recording reproduction device described later, it is possible to change the mixing conditions during synchronous reproduction, or to record the changed mixing conditions as new mixing information in a RAM unit.

Next, the multi-recording reproduction device 2A of the present invention is explained.

[Multi-Recording Reproduction Device]

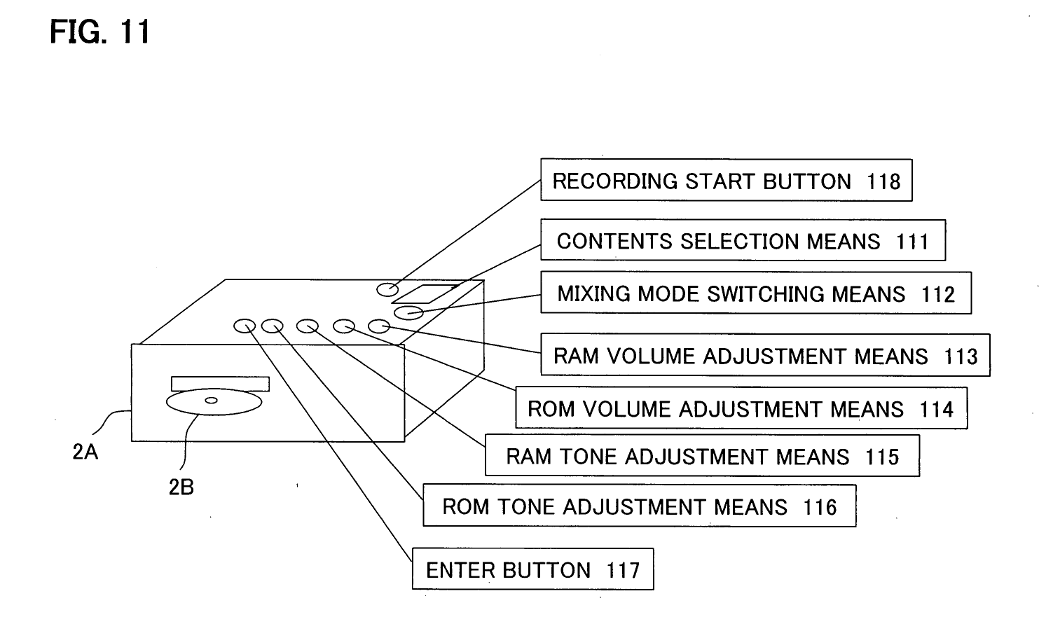

FIG. 11 is a diagram showing a configuration example of the multi-recording reproduction device 2A. Here, the concurrent ROM/RAM medium illustrated in FIG. 6 is used as the multi-recording medium 2B. As an example of the data format, the mixing information 54 of FIG. 5 and FIG. 7 are employed. An example of changing the mixing conditions upon synchronous reproduction is now explained. When the concurrent ROM/RAM medium is set, and the contents (song) recorded in the ROM unit is selected with the contents selection means 111, the contents of the RAM unit corresponding to the selected song are synchronously reproduced, and the output level ratio and the like are adjusted based on the mixing information 7b5 recorded in the RAM unit.

Next, an example of the method of mixing while reproducing the contents after recording is now explained. When the multi-recording medium is inserted into the multi-recording reproduction device 2A, the device foremost reads the TOC area 61, then reads the address 7b2 and mixing information 7b5 of the respective contents, and retains these in the TOC memory described later. Here, as an example, let it be assumed that the contents selection means 111 selected song number k.

The multi-recording reproduction device 2A reproduces song number k according to the mixing information 7b5 recorded in the TOC memory. Here, the tone is adjusted by setting the equalizer of the first contents recorded in the ROM unit and the second contents recorded in the RAM unit in accordance with the waveform characteristic information 54C recorded in the TOC memory. Further, the volume ratio is adjusted with the volume ratio adjuster in accordance with the output level ratio information 54B.

The ROM and RAM signals are, after being synthesized, converted into an analog signal with a D/A converter, and then output from the speaker. The user, while listening to this, manually operates the RAM volume adjustment means 113, ROM volume adjustment means 114, RAM tone adjustment means 115, ROM tone adjustment means 116 and so on (hereinafter referred to as mixing condition buttons) to adjusts the sound to one's preferred conditions. Moreover, when an enter button 117 is pushed, new mixing conditions are recorded in the TOC memory. The new mixing conditions recorded in the TOC memory are recorded as updated information in the TOC area 61 of the multi-recording medium 2B after the reproduction of the song is finished.

As described above, it will be possible to conduct synchronous reproduction employing the new mixing conditions in the subsequent reproduction, and the tone can be adjusted in accordance with the user's preference. The new mixing conditions are overwritten in the RAM unit, or, preferably, additionally recorded, and, when a plurality of mixing conditions exists upon synchronous reproduction, it is desirable that the mixing conditions to be employed can be selected.

The mode for changing the mixing conditions during the subsequent song is now explained. During synchronous reproduction, the mixing condition buttons are adjusted to meet the user's preferred conditions, and, upon pressing the enter button 117, in addition to volume and tone, the timing information 54D is written in the TOC memory. Timing information is, for instance, the time information from the start of the synchronous reproduction or the absolute address information recorded in the contents. At the point the song is finished, in addition to the volume, tone and the timing information is written in the TOC area 61 as the mixing information.

At the time of subsequent reproduction, as a result of performing synchronous reproduction based on the renewed mixing information 54D, the mixing conditions are changed at the set timing, and music can thereby be reproduced with the optimum mixing conditions. As a result of this kind of method, for instance, the RAM volume can be set low for the rhythm guitar part, and the RAM volume can be set high in the guitar solo part without any vocals.

The performer uses the recording start button 118 upon starting the overdubbing process. When the multi-recording medium 2B in which the contents are recorded in the ROM unit is inserted and this button is pushed, reproduction of contents of the ROM unit is started, and the input signal of an instrument to be played while listening to such contents can be recorded in the RAM unit.

The mixing mode switching means 112 is used for switching the mixing mode. For instance, a plurality of conditions are set; for instance, mode 0 is the standard reproduction mode; mode 1 is a mode for changing the mixing condition buttons such as the RAM volume adjustment means 113 available; and mode 2 is a mode for enabling the renewal of timing information, and the mixing mode switching means is used to switch these conditions.

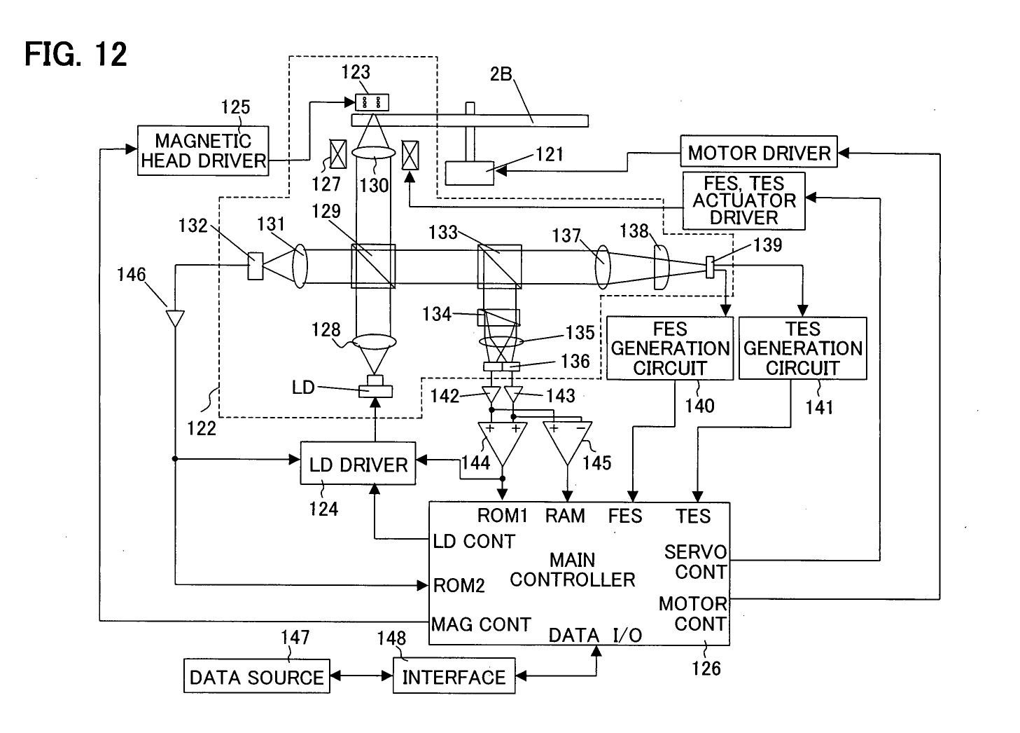

FIG. 12 is a block diagram showing a configuration example of the multi-recording reproduction device. The motor 121 shown in FIG. 12 rotates the multi-recording medium 2B. Ordinarily, the multi-information recording medium 2B is a removable medium, and is inserted from the insertion slot of the drive not shown. The optical pickup 122 has a magnetic head 123 and an optical head arranged so as to sandwich this multi-recording medium. The optical pickup 122 is moved by a track actuator (not shown) such as a ball screw feed mechanism, and is capable of accessing an arbitrary position in the radial direction of the multi-recording medium 2B. Further provided are an LD driver 124 for driving the laser diode LD of the optical head, and a magnetic head driver 125 for driving the magnetic head 123 of the optical pickup 122.

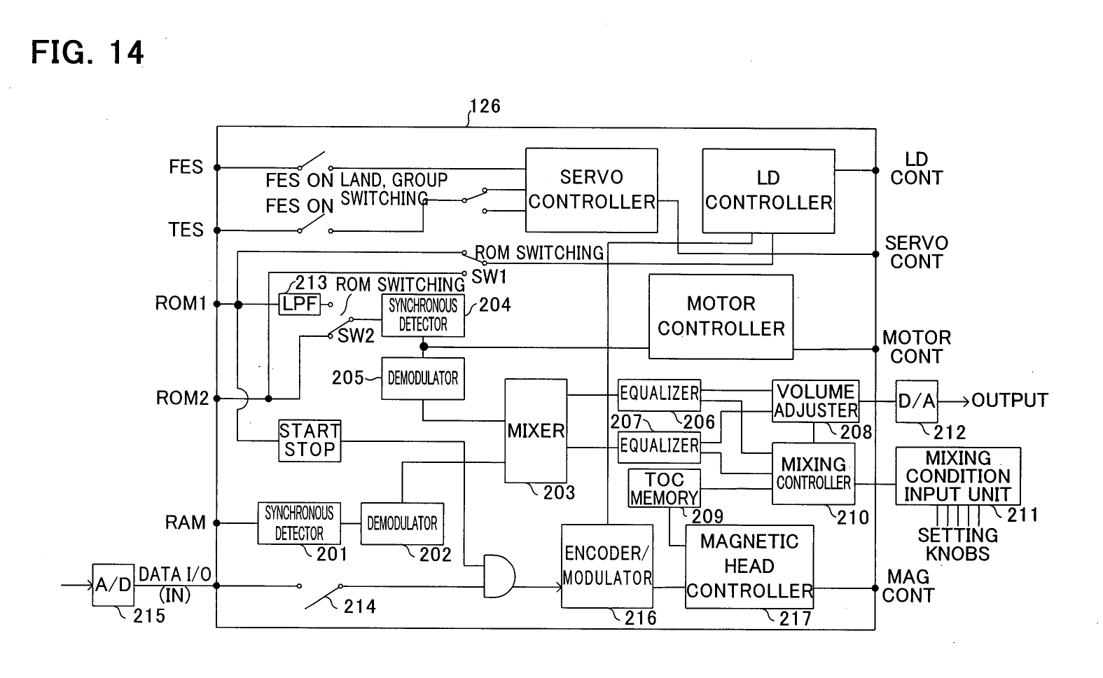

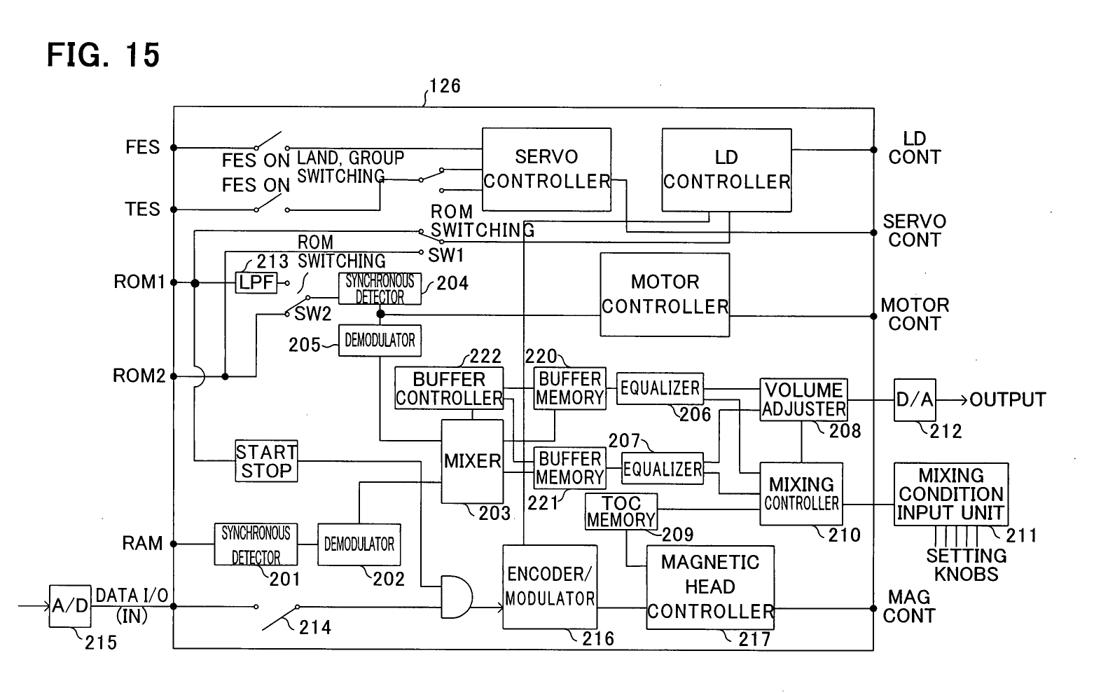

The main controller 126 is composed of the access servo controller and controller described later in FIG. 14 or FIG. 15, respectively. The access servo controller controls the track actuator, motor 121, and focus actuator 127 of the optical head based on the output from the optical head. The controller operates the LD drive 124, magnetic head driver 125, and access servo controller to record and reproduce information.

Details of the optical head are now explained with reference to FIG. 12. The diffused light from the laser diode LD will become parallel light at the collimator lens 128, and is condensed up to approximately the diffraction limit on the multi-information recording medium 2B with the object lens 130 via the polarized beam splitter 129.

A part of the light entering this polarized beam splitter 129 is reflected with the polarized beam splitter 129, and condensed at the APC (Auto Power Control) detector via the condenser lens 131.

Further, the light reflected by the multi-information recording medium 2B reenters the beam splitter 129 via the objective lens 130 once again. A part of the light that reentered the beam splitter 129 returns to the laser diode LD side, and the remaining light is reflected with the beam splitter 129, and enters the polarized beam splitter 133.

A part of the light that entered the polarized beam splitter 133 is condensed at the bi-detector 136 via the two-beam Wollaston prism 134 and condenser lens 135. Moreover, the other part of the light that entered the polarized beam splitter 133 is condensed on the tetrameric detector 139 for detecting the servo via the condenser lens 137 and cylindrical lens 138.

The FES (Focus Error Signal) reproduction circuit 140 performs focus error detection (FES) with the astigmatic method based on the outputs A, B, C and D of the tetrameric photo detector 139 subject to photoelectric exchange; in other words:
FES=(A+B)−(C+D)/(A+B+C+D).

Simultaneously, the TES generation circuit 141 according to a push-pull method is used to perform track error detection (TES) from the output of the tetrameric detector 139.

The focus error signal (FES) and track error signal (TES) obtained with the foregoing calculation are input to the main controller 126 (specifically, the access servo controller) as the positional error signals of the focus direction and track direction.

Meanwhile, in a recorded information detection system, the polarization characteristics of the reflected laser beam that changes based on the direction of the magnetization of the magneto-optical recording on the multi-recording medium 2B are converted into optical intensity. In other words, in the two-beam Wollaston prism 134, the two beams of which polarized direction are mutually orthogonal will be created by separation based on the polarization detection wave, enter the bi-photo detector 136 through the condenser lens 135, and be subject to photoelectric exchange, respectively.

The two electronic signals G, H subject to photoelectric exchange at the bi-photo detector 136 are amplified with the amplifiers 142, 143, thereafter added with the addition amplifier 144, become the first ROM signal (ROM1=G+H), and simultaneously subtracted with the subtraction amplifier 145, become the RAM read-out (MO) signal (RAM=G−H), and are respectively input to the main controller 126.

The reflected light of the semiconductor laser diode LD that entered the APC photo detector 132 is subject to photoelectric exchange and input to the main controller 126 as the second ROM signal (ROM2) via the amplifier 146.

Further, as described above, input to the main controller 126 are the first ROM signal (ROM1) as the output of the addition amplifier 144, the RAM signal (RAM) as the output of the differential amplifier 145, the focus error signal (FES) from the FES generation circuit 140, and the track error signal (TES) from the TES generation circuit 141.

Moreover, the recording data and read-out data are input and output between the data sources 147 and the main controller 126 via the interface circuit 148.

The first ROM signal (ROM1=G+H), the second ROM signal (ROM2=I) and the RAM signal (RAM=G−H) to be input to the main controller 126 are called and used corresponding to the respective modes; in other words, upon the simultaneous reproduction of the ROM and RAM, and upon the reproduction of ROM and simultaneous recording (WRITE) of the RAM.

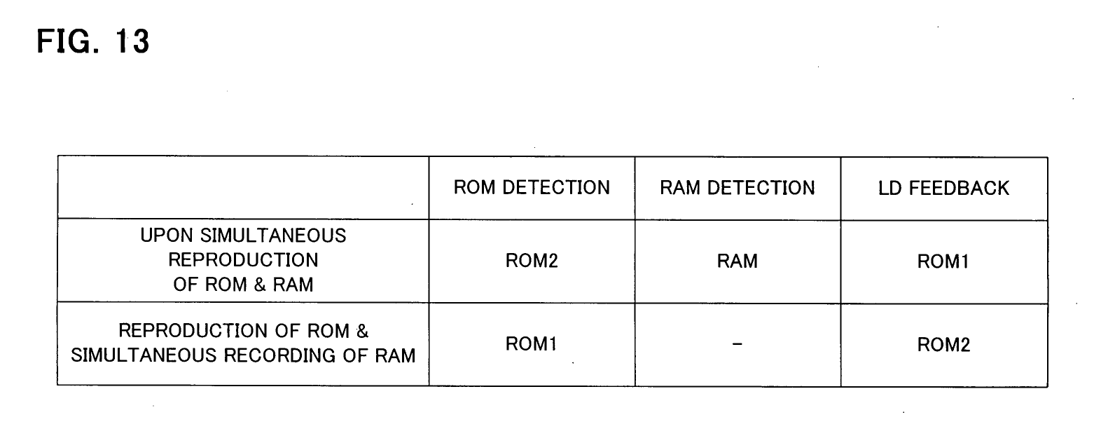

FIG. 13 is a diagram showing the combination of the detection of the foregoing ROM1 signal (=G+H), ROM2 signal (=I) and, RAM signal (=G−H) in the respective modes. The main controller 126 generates a command signal to the LD driver 124 according to the respective modes. The LD driver 124, in accordance with the command signal, controls the negative feedback of the emission power of the semiconductor laser diode LD according to the first ROM signal (ROM1=G+H) during the reproduction of the ROM and RAM, and controls the negative feedback of the emission power of the semiconductor laser diode LD according to the second ROM signal (ROM2=I) upon reproducing the ROM and recording the RAM.

During the magneto-optical (RAM) recording, data from the data source 147 is input to the main controller 126 via the interface 148. When the main controller 126 is employing the magnetic field modulation recording method, the input data is supplied to the magnetic head driver 125. The magnetic head driver 125 drives the magnetic head 123, and modulates the magnetic field in relation to the recorded data.

Thereupon, in the main controller 126, a signal for designating the time of recording is sent to the LD driver 124, and the LD driver 124 controls the negative feedback of the emission of the semiconductor laser diode LD to realize the optimum laser power for recording in accordance with the second ROM signal (ROM2=I).

Further, when employing the optical modulation recording method, this input data is sent to the LD driver 124 so as to optically modulate and drive the laser diode LD. Thereupon, in the main controller 126, the signal for designating the time of recording is sent to the LD driver, and the LD driver 124 controls the negative feedback of the emission of the semiconductor laser diode LD to realize the optimum laser power for recording in accordance with the second ROM signal (ROM2=I).

Moreover, the main controller 126 (specifically, the servo controller thereof) drives the focus actuator 127 according to the detected focus error signal FES and controls the focused focal point of the optical beam. The main controller 126 (specifically, the servo controller thereof) drives the track actuator according to the detected track error signal TES and controls the seek and track pursuit of the optical beam.

Here, a G+H (ROM1) signal of the detector 136 and the I (ROM2) signal of the detector 132 is used to adjust the laser power. As shown in FIG. 13, when simultaneously reproducing the ROM signal and RAM signal, the laser power is controlled to make the G+H signal constant such that the RAM read-out signal (=G−H) will be not subject to the cross talk from the phase pit conversion of the multi-recording medium 2B.

The multi-recording reproduction device 2A shown in FIG. 12 and FIG. 13 has an optical pickup for reading information of the ROM and RAM and a magnetic head for recording information in the RAM. In this configuration, the RAM signal can be reproduced while reproducing the ROM.

Further, as a result of subjecting the ROM1 signal to negative feedback in the laser drive unit, the intensity modulation noise to the RAM signal caused by the concavo-convex of the ROM unit of the recording medium can be reduced, and, therefore, the RAM signal can be detected accurately. Here, the ROM signal can be detected with the ROM2. The optical pickup is able to access the storage medium in an arbitrary radial position with a seek mechanism enabled by a ball screw feed mechanism. Thus, the contents recorded in the ROM and the contents recorded in the RAM can be accessed arbitrarily. Moreover, in addition to the ball screw feed mechanism, it is also possible to employ a voice coil motor (VCM) method, or a rack pinion method using a motor or gear.

FIG. 14 is a block diagram showing an embodiment of the main controller 126 illustrated in FIG. 12. In this example, the concurrent ROM/RAM medium illustrated in FIGS. 4, 6 and 8 described above is used as the multi-recording medium 2B, and explained is the main controller of the multi-recording reproduction device 2A applicable upon simultaneous reproduction.

Input to the main controller 126 are the second ROM signal (ROM2) via the amplifier 146, the first ROM signal (ROM1) as the output of the addition amplifier, the RAM signal (RAM) as the output of the differential amplifier 145, the focus error signal (FES) from the FES generation circuit 140, and the track error signal (TES) from the TES generation circuit 141.

Moreover, input to the main controller 126 is the recording data converted into a digital audio signal from data sources 147 via the interface circuit 148 including an A/D converter.

In the main controller 126, output of the differential amplifier 145, which is RAM information during the simultaneous reproduction of the ROM information and RAM information, is synchronously detected with the synchronous detection circuit 201, demodulated corresponding to the NRZI conversion or the like with the demodulator 202, decoded with the decoder 203, and output as the digital audio RAM signal.

Meanwhile, ROM2 is used as the ROM signal in the simultaneously reproduction of ROM/RAM. The ROM2 signal, as with the RAM signal, is synchronously detected with the synchronous detection circuit 204, converted into a digital audio signal with the demodulator 205 and decoder 203 and output as ROM data.

Here, since the RAM signal is output by being temporally delayed, the time delay of the ROM signal is adjusted as necessary with a delay device not shown. The user may also arbitrarily adjust this delay time. Further, the RAM signal is also time delayed as necessary with a delay device.

The output ROM signal and RAM signal are respectively input to the equalizers (tone adjusters) 206, 207, and the volume adjuster 208, and mixed with the mixing controller 210 based on the mixing information recorded in the TOC memory 209. Moreover, input from the mixing condition input unit 211 comprising setting knobs and the like may be recorded in the TOC memory as mixing information, and control may be made based on such input mixing information.

Thereafter, this is converted into an analog signal with the D/A converter 212 and output as music to the speaker, headphones 31 or the like. As described above, the ROM contents and RAM contents are synchronously reproduced, synthesized and output.

Next, during the reproduction of the ROM and recording of the RAM, as shown in FIG. 13, the ROM1 signal is used as the reproduction ROM signal. Based on the switching of the switch SW2, the ROM1 signal is synchronously detected with the synchronous detection circuit 204 via the low pass filter 213, converted into a digital audio signal with the demodulator 205 and decoder 203, and output as ROM data. Then, after the ROM data is converted into an analog music signal with the D/A converter 212, it is output as music to the likes of the speaker 3A.

In order to record music such as a guitar or vocals to the RAM while listening to this music, foremost, the recording start button 118 described above is used to switch on the input switch 214. As a result, the analog signals output from the guitar 1A, microphone 1B and piano 1C are converted into a digital signal with the A/D converter 215, subject to coding and the like of error correction with the encoder/modulator 216, and then converted into an EFM signal, NRZI signal, or the like.

Thereafter, the magnetic head controller 217 drives the magnetic head 123, and the converted information is recorded in the RAM unit of the multi-recording medium 2B. Further, when new mixing information is input, after the reproduction of the song, the information recorded in the TOC memory 209 is recorded in the RAM unit of the multi-recording medium 2B.

With the multi-recording reproduction device 2A illustrated in FIGS. 12, 13 and 14, a plurality of contents can be synchronously reproduced according to the information recorded in the RAM unit, and the information input during the synchronous reproduction can be set as new mixing information.

In correspondence with the tone adjustment means depicted in FIG. 11, although equalizers 206, 207 are illustrated in FIG. 14, these may be replaced with effectors (tone quality processing device) such as a filter; a compressor limiter for changing the input/output amplitude characteristics according to the amplitude of the input signal, a noise gate for cutting signals under a prescribed level, an expander, a digital delay for obtaining an effect of thickening the sound by delaying the signal, or a digital reverb for obtaining a reverberation effect, and so on.

FIG. 15 is a block diagram showing another embodiment of the main controller 126 illustrated in FIG. 12. In this example, the medium shown in FIGS. 9 and 10 described above as a medium other than the concurrent ROM/RAM medium is used as the multi-recording medium 2B, and explained is the main controller of the multi-recording reproduction device 2A applicable upon simultaneous reproduction.

The main controller 126 depicted in FIG. 15, unlike the example shown in FIG. 14, includes a buffer memory. As a result of temporarily storing a plurality of contents in the buffer memory, the plurality of contents can be synchronously reproduced according to the mixing information recorded in the RAM unit, and the information input during the synchronous reproduction can be set as the new mixing information. An example of the multi-recording medium employed in FIG. 15 is now explained with reference to FIG. 10. The first contents are recorded in area 101 of FIG. 10, and the second contents are recorded in area 102 of FIG. 10.

Contents are read out from the multi-recording medium of FIG. 10 inserted into the multi-recording reproduction device, and transmitted to the decoder 203 via the demodulator 205. This read-out is conducted at a bit rate that is higher than the bit rate during reproduction. The buffer controller 222, in accordance with the reception at the decoder 203, temporarily stores the first and second contents in the buffer memories 220, 221, respectively.

This differs from the concurrent ROM/RAM medium in which data is recorded in an overlapping manner, and the time difference arising pursuant to the read-out of the plurality of contents is adjusted with the buffer memories 220, 221. The contents accumulated in the buffer memories 220, 221 are output to the equalizers 206, 207, respectively, at a bit rate that is lower than the bit rate at the time of read-out, and the subsequent mixing processing is the same as the example shown in FIG. 14, and the explanation thereof is omitted.

Without having to use the concurrent ROM/RAM as the multi-recording medium, pursuant to FIGS. 12, 13 and 15, a plurality of contents can be synchronously reproduced according to the mixing information recorded in the RAM unit, and the information input during the synchronous reproduction can be set as the new mixing information.

In correspondence with the tone adjustment means depicted in FIG. 11, although equalizers 206, 207 are illustrated in FIG. 15, these may be replaced with effectors (tone quality processing device) such as a filter; a compressor limiter for changing the input/output amplitude characteristics according to the amplitude of the input signal, a noise gate for cutting signals under a prescribed level, an expander, a digital delay for obtaining an effect of thickening the sound by delaying the signal, or a digital reverb for obtaining a reverberation effect, and so on.

Although the multi-recording reproduction device in the embodiments of the present invention described above has been explained for the synchronous reproduction of multi-recorded contents, ordinary contents not subject to multi-recording can also be reproduced.

### Industrial Applicability

As described above, according to the present invention, as a result of recording the mixing information to be used upon synchronously reproducing the contents in a medium, an optimum setting is automatically recreated merely by setting the recording medium in the reproduction device. Further, even if the reproduction device is changed, since the mixing information is recorded in the medium, synchronous reproduction can be enjoyed easily without requiring any resetting. Moreover, the multi-recording reproduction device enables to change the mixing conditions during synchronous reproduction, or to record the changed mixing conditions as new mixing information in a RAM unit.

Thereby, the virtual session function and multi-recording function, which were limited to certain professionals, can be realized easily and inexpensively.

1. A disk-like multi-recording medium in which a ROM unit having information recorded therein with phase pits employing optical reflectance and a RAM unit being optically recordable and reproducible are arranged in layers, comprising:
a first area having first contents;
a second area having second contents; and
a third area having mixing information to be used upon synchronously synthesizing and reproducing said first and said second contents.

2. A multi-recording medium according to claim 1,
wherein said first area is formed in said ROM unit;
said second and said third areas are formed in said RAM unit; and
said ROM unit and said RAM unit are arranged in an overlapping manner.

3. A multi-recording medium according to claim 1,
wherein said first and said second areas are formed in said read-only ROM unit;
said third area is formed in said rewritable RAM unit; and
said ROM unit and said RAM unit are arranged in an overlapping manner.

4. A disk-like multi-recording medium in which a ROM unit having information recorded therein with phase pits employing optical reflectance and a RAM unit being optically recordable and reproducible are arranged at positions differing in the radial direction or at positions differing in the circumferential direction,
wherein a first area having first contents is formed in said ROM unit; and
a second area having second contents, and a third area having mixing information to be used upon synchronously synthesizing and reproducing said first and said second contents are formed in said RAM unit.

5. A multi-recording medium according to claim 2,
wherein said RAM unit is formed with a magneto-optical recording film.

6. A multi-recording medium according to claim 3,
wherein said RAM unit is formed with a magneto-optical recording film.

7. A multi-recording medium according to claim 4,
wherein said RAM unit is formed with a magneto-optical recording film.

8. A multi-recording medium according to claim 1,
wherein said mixing information has output level ratio information of said first and said second contents or waveform characteristic information of said first and said second contents.

9. A multi-recording medium according to claim 4,
wherein said mixing information has output level ratio information of said first and said second contents or waveform characteristic information of said first and said second contents.

10. A multi-recording medium according to claim 8,
wherein said mixing information further has timing information for changing said output level ratio or said waveform characteristic during synchronous reproduction.

11. A multi-recording medium according to claim 9,
wherein said mixing information further has timing information for changing said output level ratio or said waveform characteristic during synchronous reproduction.

12. A storage device, comprising:
an optical pickup for irradiating light to a multi-recording medium including a read-only ROM unit having first contents recorded with phase pits employing optical reflectance and a rewritable RAM unit having second contents and mixing information, and separating and detecting the information of said ROM unit and said RAM unit;
a magnetic head for recording information in said RAM unit used with said irradiated light; and
a controller for synchronously synthesizing said first and said second contents according to said mixing information and generating a reproduction signal.

13. A storage device according to claim 12,
wherein said controller further has a mixing condition input unit for inputting mixing information; and
the mixing information input during the synchronous reproduction of said first and said second contents is recorded in said RAM unit.

14. A storage device according to claim 12,
wherein said controller further has a mixing condition input unit for inputting mixing information; and
the reproductive state of said first and said second contents is changed according to the mixing information input during the synchronous reproduction of said first and said second contents.

15. A storage device according to claim 12,
wherein said mixing information has output level ratio information of said first and said second contents or waveform characteristic information of said first and said second contents.

16. A storage device according to claim 13,
wherein said mixing information has output level ratio information of said first and said second contents or waveform characteristic information of said first and said second contents.

17. A storage device according to claim 14,
wherein said mixing information has output level ratio information of said first and said second contents or waveform characteristic information of said first and said second contents.

18. A storage device according to claim 15,
wherein said mixing information has timing information for changing said output level ratio or said waveform characteristic during synchronous reproduction.

19. A storage device according to claim 18,
wherein said controller changes said first or said second output level ratio or waveform characteristic based on said timing information during synchronous reproduction.

20. A storage device, comprising:
an optical pickup for irradiating light to a multi-recording medium including a read-only ROM unit having first contents recorded with phase pits employing optical reflectance and a rewritable RAM unit having second contents and mixing information, and detecting the information of said ROM unit and said RAM unit;
a buffer memory for temporarily storing said first and said second contents detected with said optical pickup;
a magnetic head for recording information in said RAM unit used with said irradiated light; and
a controller for synchronously synthesizing said first and said second contents stored in said buffer memory according to said mixing information and generating a reproduction signal.
